(19) United States
(12) Patent Application Publication
(10) Pub. No.: US 2022/0327486 A1
(43) Pub. Date: Oct. 13, 2022

(54) KANBAN-BASED WORK PROCESSING DEVICE AND WORK PROCESSING METHOD

(71) Applicants: Jae Ho Choi, Seoul (KR); DELTA PDS CO., LTD., Seoul (KR)

(72) Inventor: Jae Ho CHOI, Seoul (KR)

(73) Assignees: Jae Ho Choi, Seoul (KR); DELTA PDS CO., LTD., Seoul (KR)

(21) Appl. No.: 17/333,734

(22) Filed: May 28, 2021

(30) Foreign Application Priority Data
Apr. 9, 2021 (KR) 10-2021-0046707
May 14, 2021 (KR) 10-2021-0062822

(51) Int. Cl. G06Q 10/10

(52) U.S. Cl. CPC G06Q 10/107; G06Q 10/103

(57) ABSTRACT

A Kanban-based work processing device includes: a Kanban card creation part that detects the creation of a task project from a Kanban board and creates a Kanban card; a Kanban card handling part that embeds a work chat room-only container for the task project into the Kanban card; a work chat room handling part that creates a work chat room in the work chat room-only container and allows participants to share task messages through the work chat room; and a reminder management part that creates a reminder message about task details in the Kanban card and allows the same to be shared through the work chat room.

### CROSS-REFERENCE TO RELATED APPLICATIONS

This application claims priority to Korean Patent Application Nos. 10-2021-0062822 filed on May 14, 2021 and 10-2021-0046707 filed on Apr. 9, 2021, which are all hereby incorporated by reference in their entirety.

### BACKGROUND

The present disclosure relates to a work processing and management technique, and more particularly, to a technique that provides effective support to perform work by providing a means of communication between task participants, such as a work chatroom for a Kanban board or work chat rooms for Kanban cards in the Kanban board.

Internet messengers generally refer to applications that deliver messages containing text or graphics between users, which may be implemented by a chat room where multiple users can join. In an embodiment, internet messengers may include mobile messengers that run in a mobile environment (e.g., mobile phone)—for example, KakaoTalk, Line, WeChat, and Facebook Messenger. Also, such internet messengers are becoming more and more diverse in use when it comes to work management and progress.

A Kanban board is one of the tools that can be used to implement Kanban to manage work at a personal or organizational level. Kanban boards visually organizes various stages of a task and subtasks in each stage of the task in a plane. Kanban boards use cards to arrange different stages of an entire process of a higher-level task in one direction to represent work items. For example, Kanban cards are moved from left to right through different stages of work to show progress.

Kanban is one of the software development processes, and its concept was originated from a development methodology that encourages developers to ship a product at right time without giving them much pressure.

### PRIOR ART DOCUMENT

### Patent Document

Korean Laid-Open Patent No. 10-2017-0040928 (published on 14 Apr. 2017).

### SUMMARY

The present disclosure provides a Kanban-based work processing device and work processing method that enable a user to see at a glance the progress of an ongoing project through a Kanban board, to give feedback on tasks and rework them in an effective way through a chat room uniquely associated with a Kanban card and a separate chat room associated with a task note, and to easily understand the workflow through system messages and reminders which are created and shared as work progresses, thereby improving the efficiency of work.

An exemplary embodiment of the present disclosure provides a Kanban-based work processing device including: a Kanban card creation part that detects the creation of a task project from a Kanban board and creates a Kanban card; a Kanban card handling part that embeds a work chat room-only container for the task project into the Kanban card; a work chat room handling part that creates a work chat room in the work chat room-only container and allows participants to share task messages through the work chat room; and a reminder management part that creates a reminder message about task details in the Kanban card and allows the same to be shared through the work chat room.

The Kanban card handling part may embed a task note-only container for the task project into the Kanban card.

The Kanban-based work processing device may further include a task note handling part that creates task notes in the task note-only container so that the participants share basic information about the task.

The task note handling part may detect a file message uploaded onto the work chat room and create a file-based task note on the file message.

The work chat room handling part may detect the creation of the task note and create a task note-based work chat room associated with the task note in the work chat room-only container so that the participants share individual messages about the task note.

Once a task note-based task object is created through the task note-based work chat room, the work chat room handling part may automatically create a system message for the task note-based task object and allow the system message to be shared through the task note-based work chat room.

The Kanban card handling part may embed a task object-only container for the task object into the Kanban card.

The Kanban-based work processing device may further include a task object handling part that creates a task object in the task object-only container, the task object consisting of a task owner, a task assignee, and task details contained in the task message, and provides the task object to the work chat room so that the participants share the assigned task.

The task object handling part may create a task object based on a chat message, a task message, or a system message, whichever specifies a particular participant.

The task object handling part may embed a task note-based task object created through a task note-based work chat room in the task object-only container.

The work chat room handling part may detect a change in the status of the Kanban card and automatically create a system message about the change in the status and allow the same to be shared through the work chat room.

If an external user with no authorization to access the Kanban board is invited to join the work chat room, the external user may be given authorization to access the Kanban board, Kanban card, or task note.

The reminder management part may create a reminder message as a system message based on a work schedule for the task and allow the same to be shared through the work chat room.

The reminder management part may create the reminder message to send to at least some participants by setting reminders to periodically create task notes or reminders for a workflow-based deadline of a task object.

The reminder management part may set up a new occurrence interval when the task note occurs and update the reminder message at every interval the task note occurs, based on the number of repetitions of the same reminder message.

If the Kanban card includes a plurality of tasks having respective deadlines, the reminder management part may create a reminder message associated with each of the plurality of tasks and allow the same to be shared through the work chat room.

If the plurality of tasks are sequentially linked according to a sequence of work, the reminder management part may create an integrated reminder message associated with the sequence of work and allow the same to be shared through the work chat room.

Another exemplary embodiment of the present disclosure provides a work processing method performed by a Kanban-based work processing device, the work processing method including: detecting the creation of a task project from a Kanban board and creates a Kanban card; embedding a work chat room-only container for the task project into the Kanban card; creating a work chat room in the work chat room-only container and allowing participants to share task messages through the work chat room; and creating a reminder message about task details in the Kanban card and allowing the same to be shared through the work chat room.

### BRIEF DESCRIPTION OF THE DRAWINGS

FIG. is a view illustrating a work processing system according to the present disclosure.

FIG. 2 is a view illustrating a system configuration of the work processing device of FIG. 1.

FIG. 3 is a view illustrating a functional configuration of the work processing device of FIG. 1.

FIG. 4 is a sequential chat of a Kanban-based work processing method according to the present disclosure.

FIG. 5 is a view illustrating a Kanban board according to an exemplary embodiment of the present disclosure.

FIG. 6 is a view illustrating a Kanban card according to an exemplary embodiment of the present disclosure.

FIGS. 7A and 7B are views illustrating work chat rooms and a reminder sharing process.

FIG. 8 is a flowchart illustrating a Kanban-based work processing method according to an exemplary embodiment of the present disclosure.

FIG. 9 is a flowchart illustrating a Kanban-based work processing method according to an exemplary embodiment of the present disclosure.

### DETAILED DESCRIPTION

The description of the present disclosure is merely an example for structural or functional explanation, and therefore, the scope of the present disclosure should not be construed as being limited by the embodiments described in the text. That is, since the embodiments can be variously embodied and have various forms, the scope of the present disclosure should be understood to include equivalents capable of realizing technical ideas. Also, since the purpose or effect set forth in the present disclosure is not intended imply that to the specific embodiment, the scope of the present disclosure should not be construed as being limited thereto.

Meanwhile, the meaning of the terms described in the present application should be understood as follows.

The terms such as “the first”, “the second”, and the like, are intended to distinguish one element from another, and the scope of the right should not be limited by these terms. For example, the first component may be referred to as the second component, and similarly, the second component may also be referred to as the first component.

It is to be understood that when an element is referred to as being “connected” to other element, it may be directly connected to the other element, but there may also be other elements in between. On the other hand, when an element is referred to as being “directly connected” to other element, it should be understood that there is no other element in between. On the other hand, other expressions that describe the relationship between elements, that is, “between˜” and “just between˜” or “adjacent to˜” and “directly adjacent to˜” should be interpreted likewise as well.

The singular expressions should be understood to include plural expressions unless the context clearly dictates otherwise. It is also to be understood that the terms “comprise”, “include”, “have”, and the like, are to designate the presence of practiced features, numbers, steps, operations, elements, parts, or combinations thereof, but do not preclude the presence or addition, possibility of one or more other features, numbers, steps, operations, elements, parts, or combinations thereof.

In each step, the identification code (e.g., a, b, c, etc.) is used for convenience of explanation, but the identification code does not describe the order of each step, and unless otherwise explicitly stated, it may occur differently from the stated order. That is, each of steps may occur in the same order as described, may also be performed substantially at the same time, and may be performed in reverse order.

The present disclosure can be embodied as a computer-readable code on a computer-readable recording medium, and the computer-readable recording medium includes all kinds of recording devices for storing data, which can be read by a computer system. Examples of the computer-readable recording medium include ROM, RAM, CD-ROM, magnetic tape, floppy disk, optical data storage device, and the like. In addition, the computer-readable recording medium may be distributed over network-connected computer systems so that computer readable codes can be stored and executed in a distributed manner.

All terms used herein have the same meaning as commonly understood by one of ordinary skill in the art to which this invention belongs, unless otherwise defined. Terms defined in commonly used dictionaries should be interpreted to be consistent with meaning in the context of the related art and cannot be interpreted as having ideal or overly formal meaning unless explicitly defined in the present application.

FIG. is a view illustrating a work processing system according to the present disclosure.

Referring to FIG. 1, the work processing system 100 may include a plurality of user terminals 110 and a work processing device 130.

In an exemplary embodiment of the present disclosure, a plurality of users may be included in one or more user groups. One or more user groups may be referred to as a first user group, a second user group, and so on. One user may be included in one or more user groups.

A first user terminal 110a is a terminal of a first user. A second user terminal 110b may correspond to a terminal of a second user, a third user terminal 110c may correspond to a terminal of a third user, and a fourth user terminal 110d may correspond to a terminal of a fourth user.

Here, the first through fourth users may collaborate as participants on one or more Kanban boards. For a task performed through one Kanban board, one or more of the first through fourth users may be task owners, and another one or more of them may be task assignees. Other participants apart from the task owner(s) and the task assignee(s) may be classified as task followers.

The first through fourth users may collaborate on an entire project, and the entire project may progress in stages through a Kanban board. Also, there may be multiple task projects that are included in or subordinate to the entire project. Moreover, there may be one or more subtasks that are included in or subordinate to each task project. Big and small pieces of work may be created as subtasks in the process of carrying out the task project, and they may be referred to as task objects (or tasks).

These task objects may be uploaded and managed on Kanban cards. That is, one task project may progress in stages through a Kanban card, and different task objects subordinate to the task project may be performed and managed through task notes uploaded onto the Kanban card. Also, the task project may go through a number of phases of work progress which are classified based on its progress or status.

For example, the phases of work progress may include “in progress”, “under review”, “reworking”, and “rework completed” according to the PDCA cycle. The PDCA cycle is known as a systematic and efficient work management approach used to improve work performance and outcomes. “P” stands for Plan—that is, setting objectives for projects (or tasks) and establishing concrete strategies and activity plans to realize the objectives. “D” stands for Do—that is, practically performing work on planned items according to rules, guidelines, standards, etc. “C” stands for Check, which means checking work results from the D phase and analyzing and evaluating them to see any differences with the original goals and find parts that need to be improved or reworked. “A” stands for Act, in which necessary measures can be taken for improvement and rework, such as modifying the existing work results or reworking the task to address the problems and opportunities for improvement identified in the previous C phase.

That is, once the details of an assignment are uploaded onto a Kanban card by the task owner (Plan, P), the Kanban card moves into the “in progress” phase. When the task assignee has completed the task as assigned by the task owner and uploaded the completed task (Do, D), the Kanban card moves into the “under review” phase. In this case, task-related information entered by the task owner or task assignee may be written as a task note and uploaded onto the Kanban card, and both the writing and the uploading may change the status of the Kanban card. Moreover, task-related information subordinate to the task note may be created as a task object, i.e., a task, and managed in association with the task note, and an update the task object may lead to an update to the associated task note and Kanban card.

Moreover, the task owner may review a completed task in the “under review” Kanban card” (Check, C) and close the task. In this case, the Kanban card may move to the “closed” phase. Alternatively, the task owner may ask the task assignee to rework the completed task after reviewing it. Once a rework request or a rework instruction is uploaded onto the Kanban card by the task owner, the Kanban card may move to the “reworking” phase, and the status of the Kanban card may be changed as well.

In a case where the task assignee has reworked the completed task as instructed by the task owner (Act, A), once the reworked task is uploaded onto the Kanban card by the task assignee or the uploaded reworked task is confirmed by the task owner, the Kanban card may be set to the “rework completed” phase. Also, individual Kanban cards may be classified according to the phases of work progress and arranged in the Kanban board.

The work processing device 130 corresponds to a computing device that can be connected to at least one user terminal 110 over a network. In an exemplary embodiment, the work processing device 130 may manage at least one user group in which other users associated with one user are included as team members, i.e., task participants.

In an exemplary embodiment, the work processing device 130 may be connected to a user terminal 110 through a shared folder agent installed on the user terminal 110. Here, the shared folder agent corresponds to an agent program, which is a type of software that, when installed, allows the user terminal 110 and the work processing device 130 to interoperate with the approval of the user terminal 100.

A folder or file to be shared may be, but not limited to, located within a shared folder provided by the work processing device 130. A folder or file to be shared may be located in a shared folder provided by the work processing device 130 or in a personal folder of a file sharer.

The user terminal 110 may correspond to a computing device that may be connected to the work processing device 130 over a network—for example, a terminal that is implemented as a desktop, a laptop, a tablet PC, or a smart phone.

In an exemplary embodiment, at least one of the user terminals 110 may be a mobile terminal and connected to the work processing device 130 via cellular communication or WiFi communication. In another exemplary embodiment, at least one of the user terminals 110 may be a desktop and connected to the work processing device 130 through the internet.

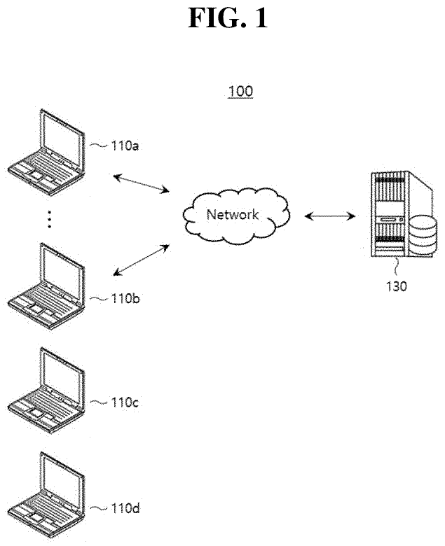

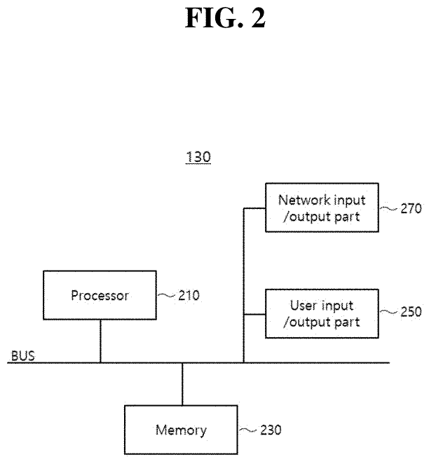

FIG. 2 is a view illustrating a system configuration of the work processing device of FIG. 1.

Referring to FIG. 2, the work processing device 130 may include a processor 210, a memory 230, a user input/output part 250, and a network input/output part 270.

The processor 210 may execute a work schedule display procedure according to an exemplary embodiment of the present disclosure, manage the memory 230 from or to which data is read or written during this process, and schedule a time for synchronization between volatile memory and nonvolatile memory in the memory 230.

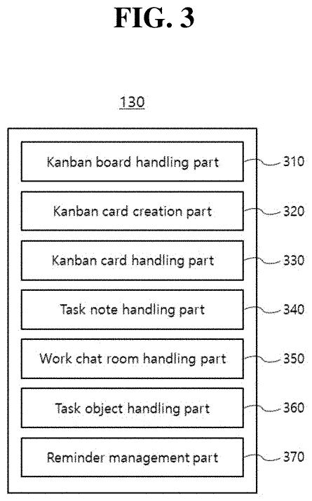

The processor 210 may control the overall operation of the work processing device 130, and may be electrically connected to the memory 230, the user input/output unit 250, and the network input/output part 270 to control the flow of data between them. The processor 210 may be implemented as a central processing unit (CPU) of the work processing device 130. More specific details of the operation of the processor 210 will be described in details later with reference to FIG. 3.

The memory 230 may include auxiliary storage which is implemented as nonvolatile memory such as a solid state disk (SSD) or a hard disk drive (HDD) and used to store all data required for the work processing device 130, and may include primary storage which is implemented as volatile memory such as random access memory (RAM). This way, the memory 230 may be implemented as volatile and nonvolatile memory, and may be connected by a hyperlink if implemented as nonvolatile memory.

The user input/output part 250 may include an environment for receiving user input and an environment for outputting specific information to the user. For example, the user input/output part 250 may include an input device including an adapter such as a mouse, a trackball, a touchpad, a graphics tablet, a scanner, a touchscreen, a keyboard, or a pointing device or connected to that adapter and an output device including an adapter such as a monitor or a touchscreen. In an exemplary embodiment, the user input/output unit 250 may correspond to a computing device connected via remote access, in which case the work processing device 130 may serve as a server.

The network input/output part 270 may include an environment for connecting to a user terminal 120 over a network—for example, an adapter for local area network (LAN) communication.

FIG. 3 is a view illustrating a functional configuration of the work processing device of FIG. 1.

Referring to FIG. 3, the processor 210 of the work processing device 130 may include a Kanban board handling part 310, a Kanban card creation part 320, a Kanban card handling part 330, a task note handling part 340, a work chat room handling part 350, a task object handling part 360, a reminder management part 370, and a controller (not shown in FIG. 3).

However, the processor 210 according to the exemplary embodiment of the present disclosure does not necessarily include all of the above components, and some of the above components may be omitted depending on each exemplary embodiment and the processor 210 may selectively include some or all of the above components.

The Kanban board handling part 310 may create a user-based Kanban board. That is, a Kanban board may be created corresponding to an entire project, and various task projects created along with the progress of the entire project may be classified and managed according to the phases of work progress. The task projects may be created respectively corresponding to the Kanban cards and embedded into the Kanban board.

Moreover, the Kanban board handling part 310 may be accessed by a user group of one or more users, and may receive a user selection signal from a user terminal 110 to select a Kanban board provided through the user terminal 110 or one or more Kanban cards within the Kanban board.

More specifically, the Kanban board handling part 310 saves, manages, and updates user information of users participating in a Kanban board by receiving user information on one or more users from the user terminal 110 via the user input/output part 250. The Kanban board handling part 310 may provide user information it has collected to create the Kanban board, at various steps of operation which are required later for project management, including handling Kanban cards, creating task notes, creating task objects, creating work chat rooms, and creating reminder messages.

Additionally, if necessary, the Kanban board handling part 310 may provide user information it has collected to create the Kanban board, in the process of managing work schedules related to the Kanban board or Kanban cards. The Kanban board handling part 310 may provide necessary user information when creating or running a work chat room as well.

Furthermore, the Kanban board handling part 310 may create user groups for work chat rooms if required, and may save and manage information such as names of user groups, criteria for user group classification, team members, information for identification of chat rooms that match different user groups, classifications or divisions of users by group, and information on the management of authorization of users or user groups.

That is, if a user's user group differs depending on the user's division or position, the Kanban board handling part 310 may set identification information of user groups that match their division, department, or position, or, if a user group is designated for each individual user, the Kanban board handling part 310 may save information on the designated user group.

Furthermore, the Kanban board handling part 310 may set or save information about each user's authorization to access, open, and edit chat rooms, files, Kanban cards, or Kanban boards. A Kanban board may be configured such that only the users of a certain user group access it. In this case, only users who are authorized to access the corresponding Kanban board may be designated as participants in chat rooms associated with the Kanban board, Kanban card, and task note.

If an external user with no authorization to access the Kanban board is invited to join a work chat room, the external user may obtain authorization to access the corresponding Kanban board, Kanban card, or task note. In this case, their authorization to access the Kanban board, Kanban card, or task note may be limited. For example, an external user may access only through a work chat room, but the authorization of access obtained through a work chat room associated with a particular Kanban card may give them no access to other Kanban cards within the same Kanban board. Similarly, the authorization of access obtained through a work chat room associated with a particular task note may give them no access to other task notes within the same Kanban card.

In an exemplary embodiment, the Kanban board handling part 310 may provide the user terminal 110 a user interface for receiving work material or user signals related to the Kanban board. The Kanban board handling part 310 may receive user signals including either or both of a signal requesting to create an entire project and a deadline setting signal from the user terminal 110 via the user interface.

If there are one or more work chat rooms created in relation to the Kanban board, the Kanban board handling part 310 may display a list of associated chat rooms, along with the corresponding Kanban board. Also, along with the list of work chat rooms for the Kanban board, the Kanban board handling part 310 may provide access routes to the corresponding chat rooms as hyperlink information.

Moreover, the Kanban board may include first through third integration containers which provide integrated management of task notes, work chat rooms, and task objects created in association with multiple Kanban cards. That is, the task notes created in association with the Kanban cards may be embedded into the first integration container for integrated management, and the work chat rooms and the task objects may be embedded into the second and third integration containers, respectively, for integrated management. As a result, the first integration container may correspond to a task note integration container, the second integration container may correspond to a work chat room integration container, and the third integration container may correspond to a task object integration container. In an exemplary embodiment, the first through third integration containers may correspond to DO, CHECK, and ACT tabs to provide management according to the phases of work progress.

In addition, the above description of the operation of the Kanban board handling part 310 may apply equally to other components, that is, the Kanban card handling part 330, the task note handling part 340, the work chat room handling part 350, and the task object handling part 360, and redundant explanations will be omitted hereinafter.

The Kanban card creation part 320 may detect the creation of a task project from a Kanban board and automatically create a Kanban card for the management of the task project. That is, a Kanban card may be created for each individual task project that is created along with the progress of an entire project, and the status of the Kanban card may be updated in sync with the progress of the corresponding task project. The Kanban card creation part 320 may receive user information collected for the creation of a Kanban board from the Kanban board handling part 310. In an exemplary embodiment, the Kanban card creation part 320 may be included in the Kanban card handling part 330.

In an exemplary embodiment, the Kanban card creation part 320 may create a new Kanban card each time a new task project is created and embed it into the Kanban board. That is, a Kanban card may be created corresponding to a task project and used to manage the progress of the corresponding task project. The Kanban cards embedded into the Kanban board may be classified and managed according to the phases of work progress, and the phases of work progress may include “in progress”, “under review”, “reworking”, and “rework completed”.

The Kanban card handling part 330 may embed a Kanban card into the Kanban board to manage a particular task project. That is, the Kanban card handling part 330 may control and handle the execution of operations associated with the Kanban card, as well as providing basic management features such as creating, modifying, and deleting the Kanban card, by interoperating with the Kanban card creation part 320. A Kanban card created by the Kanban card creation part 320 may be embedded into the Kanban board, and may be used for the Kanban card handling part 330 to carry out the task project and manage logs.

Meanwhile, the Kanban card may include at least one dedicated container that manages task notes, work chat rooms, and task objects separately. Here, a first dedicated container may correspond to a task note-only container, a second dedicated container may correspond to a work chat room-only container, and a third dedicated container may correspond to a task object-only container. That is, task notes may be embedded into the first dedicated container for management, work chat rooms may be embedded into the second dedicated container for management, and task objects may be embedded into the third dedicated container for management.

Moreover, once the details of an assignment or a rework instruction is uploaded onto a Kanban card, the Kanban card handling part 330 may make this Kanban card look different from how it looked before the details of the assignment or the rework instruction is uploaded. In this case, the user is able to know intuitively whether the details of a new assignment or a rework instruction has been uploaded or not, just by seeing how the Kanban card looks.

In an exemplary embodiment, a Kanban card may be configured by setting reminders to periodically create task notes or reminders for a workflow-based deadline. The Kanban card may be defined to include a preset task requirement according to the type of the task project. That is, reminders may be set to initiate the creation of reminder messages provided through a work chat room according to the progress of work, and reminders may be set to urge the participants to perform certain actions. For example, a Kanban card may include a task requirement that requires task notes to periodically occur along with the progress of work or a task requirement that requires a task to be done before a set deadline according to the workflow.

Moreover, a Kanban card may include task notes for sharing basic information about the task between the participants, task objects for sharing assigned tasks between the participants, and a plurality of work chat rooms associated with the corresponding Kanban card or task notes.

In this case, the Kanban card may manage the plurality of task notes, work chat rooms, and task objects in lists, and may include dedicated containers for them. Basically, the participants in the corresponding task project may have limited access to the work chat rooms associated with the Kanban card. That is, Kanban cards may be used as a means of recording and managing the whole procedure of each task project, and may be used as a means for managing tasks for the entire project within the Kanban board.

In an exemplary embodiment, once a Kanban card is created, the Kanban card handling part 330 may embed by default a work chat room-only container (i.e., second dedicated container) for the task project into the Kanban card. That is, the Kanban card may have a link to its own work chat room, through which the participants in the corresponding task project may share messages between them.

In an exemplary embodiment, the Kanban card handling part 330 may selectively embed a task note-only container (i.e., first dedicated container) for the task project into the Kanban card. In this case, task notes created in association with the corresponding Kanban card may be embedded into the task note-only container for management.

In an exemplary embodiment, the Kanban card handling part 330 may selectively embed a task object-only container (i.e., third dedicated container) for the task project into the Kanban card. In this case, task objects created in association with the corresponding Kanban card may be embedded into the task object-only container for management. The task objects may be created in association with the Kanban card or in association with the task notes.

The task note handling part 340 may create task notes in the task note-only container so that the participants in a particular task project share basic information about the task. The participants may create task notes via a dedicated interface provided in a first work chat room associated with the Kanban card and via a dedicated interface provided in the task note-only container (or the DO tab of the Kanban card). The created task note may be saved in association with the corresponding Kanban card, and may be added to the first integration container of the Kanban board and shared as basic information about the task between the participants of the entire project. The task notes may contain basic information about the task to keep track of the progress of the task project or brief comments to keep the participants informed.

In an exemplary embodiment, the task note handling part 340 may detect a file message uploaded onto a work chat room and create a file-based task note on the file message. That is, the task note may be created in file format, and a file created or uploaded by a participant may be defined as a separate task note and added to the Kanban card. For example, a first work chat room or task note-only container based on a Kanban card may provide a dedicated interface for creating task notes, and, when a file message containing a file is uploaded by a participant, the file in the corresponding file message may be shared with other participants.

In an exemplary embodiment, the task note handling part 340 may provide a task message containing a permanent link to a task note in a work chat room. Here, the work chat room may correspond to a work chat room shared via the second integrated container of the Kanban board by default. That is, logs on task notes may be shared as task messages (or system messages) via a work chat room uniquely linked to the Kanban card. If external sharing is enabled and a permanent link is embedded into a task note, this permanent link may be embedded into a task message associated with the corresponding task note as well. Since the work chat room through which this task message is shared is shared outside the Kanban card through the second integration container, so that other people who do not participate in the task project may access the corresponding task note via the permanent link in the task message.

When a Kanban card is created, the work chat room handling part 350 may create a first work chat room associated with the corresponding Kanban card in the work chat room-only container so that the participants share conversations, task messages, and system messages related to the corresponding Kanban card. That is, the first work chat room may correspond to a work chat room uniquely linked to a particular Kanban card. Here, the system messages are messages associated with a Kanban card, and may correspond to messages about changes in the status of the Kanban card. The system messages may partially overlap the task messages, and may be defined as separate notification messages which are distinguished from the task messages when necessary.

For example, the first work chat room may provide information on note logs, conversations, task logs, etc. associated with the corresponding Kanban card in the form of messages. Accordingly, the participants may see logs of all activities for the corresponding task project by viewing task messages or system messages, and may see message logs that are organized in chronological order or by task assignee or task owner.

Moreover, when a task note is created, the work chat room handling part 350 may create a second work chat room associated with the task note in the work chat room-only container so that the participants share individual messages about the task note. Here, the individual messages may include chat messages, task messages, and system messages. That is, the second work chat room may correspond to a task note-based work chat room uniquely linked to a particular task note. Accordingly, the work chat room handling part 350 may create a second work chat room each time a new task note occurs within a Kanban card and embed it into the work chat room-only container, and the participants associated with the task note may join the second work chat room and share conversations related to this task note.

Meanwhile, the first and second work chat rooms each may allow for sharing of system messages, as well as chat messages or task messages about the Kanban card and task note, and may provide their own task object creation feature. That is, a task object (or task) associated with the Kanban card may be created via a dedicated interface provided within the first work chat room, and a task object (or task) associated with the task note may be created via a dedicated interface provided within the second work chat room.

Therefore, logs (including creations, modifications, and deletions) on multiple task objects associated with one Kanban card may be shared as task messages or system messages with other participants through the first work chat room. Also, logs (including creations, modifications, and deletions) on multiple task objects associated with one task note may be shared as task messages or system messages with other participants through the second work chat room.

In an exemplary embodiment, the work chat room handling part 350 may detect a change in the status of the Kanban card and automatically create a system message about the change in the status and allow it to be shared through the first work chat room. The status of the Kanban card may be updated based on changes to the task with the progress of work, and the status of the Kanban card may be changed.

Moreover, the status of the Kanban card may be divided into a first type in which the card status changes with time and a second type in which the card status changes with the progress of work. For example, the status of the first type may be defined as “scheduled”, “in progress”, “overdue”, and “confirmed”. Also, the status of the second type may be defined as “new”, “doing”, “done”, and “confirmed”. However, it is needless to say that the status of the Kanban card may be defined as various combinations by changing the definitions of statuses and the number of statuses as necessary.

In an exemplary embodiment, the work chat room handling part 350 may create a task link for immediate access to a task object in the process of creating a task message or a system message and embed it into the corresponding task message or system message. The created task message or system message may be shared through the corresponding work chat room, and the participants in this work chat room may directly access the corresponding task object and easily see related details of the task.

Meanwhile, even someone who is able to join the work chat room and see task messages or system messages with task links embedded in them may be given no access through these task links if they have no authorization to access the corresponding task object. For example, a task message or system message with a task link embedded in it may be shared with participants associated with the Kanban card through the first work chat room, and participants not associated with the corresponding task object may be given no access to the corresponding task object, regardless of whether they have access to the first work chat room or not.

In an exemplary embodiment, the work chat room handling part 350 may create a one-on-one work chat room in the work chat room-only container, upon receiving a request for a one-on-one chat with a particular participant about a particular task object. One-one-one chat rooms embedded into the work chat room-only container may be viewed in list form on the DO tab of the Kanban card, along with the first work chat room associated with the Kanban card and the second work chat room associated the task note. The work chat room handling part 350 may create an associated work chat room by default each time a new Kanban card or a new task note is created, and may create a one-on-one chat room where only certain participants can join, according to an one-on-one chat request from a participant. Moreover, the one-on-one chat room may be added to the second integration container of the Kanban board, and may be managed separately from the work chat room-only container of the Kanban card.

In an exemplary embodiment, when a file is uploaded through a work chat room, the work chat room handling part 350 may handle the file as a task note or a task object according to the control of the participant. The work chat room handling part 350 may provide an interface for file uploading within the work chat room. By this, the participant has control over switching the file into a task note or task object, as well as uploading the file.

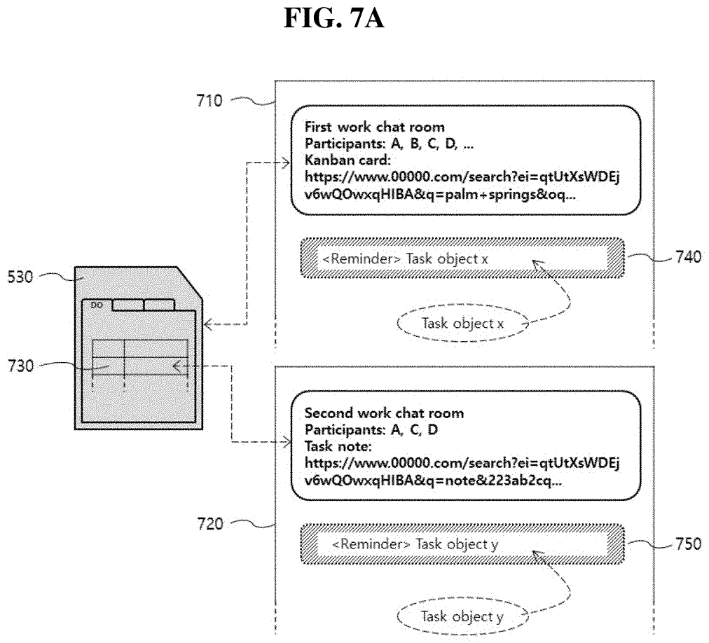

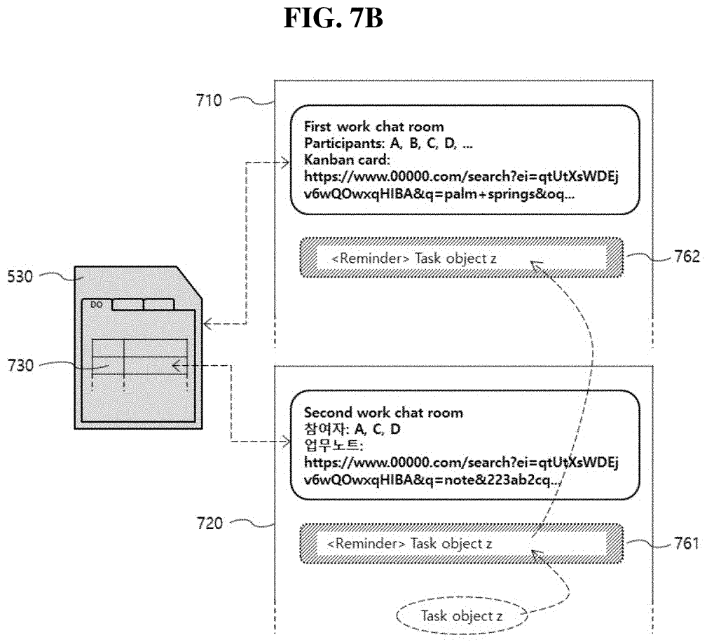

In an exemplary embodiment, when a task object is created through the second work chat room, the work chat room handling part 350 may allow a system message about the corresponding task object to be shared through the second work chat room and the first work chat room. This will be described in more details with reference to FIGS. 7A and 7B.

The task object handling part 360 may create a task object in the task object-only container, the task object consisting of a task owner, a task assignee, and task details contained in the task message, and provide the task object to the work chat room so that the participants share the assigned task. Moreover, the task object handling part 360 may provide their own task object creation features through the first and second work chat rooms. Accordingly, the participants may create a task object (or task) via a dedicated interface while participating in each work chat room, and once a task object is created within a work chat room, may share system messages and reminder messages for the corresponding task object through the corresponding work chat room.

In addition, the created task object may be saved in association with the corresponding task note and the corresponding Kanban card, and may be added to the third integration container of the Kanban board and shared as an assigned task between the participants of the entire project. Meanwhile, the task object may include an assigned task, which is a new task the task owner assigns to the task assignee in relation to the progress of a task project, and a rework task, which is a task the task owner assigns after reviewing the completed task.

In an exemplary embodiment, the task object handling part 360 may create a task object based on the workflow between the task owner and the task assignee. The task object may further include a task deadline, and the task deadline may include a start date and a due date. That is, the task object may be defined as various tasks required for the progress of a task project, and a task deadline (or due date) may be automatically set up based on the date of creation, depending on whether this task prioritizes other tasks in the workflow or not. Moreover, the task object may include the task owner who assigns the task and the task assignee who performs the task.

In an exemplary embodiment, the task object handling part 360 may manage a workflow-based task object according to its task status. The task object may further include a task status. For example, a task object created along with the progress of a task project may include one of the following task statuses: new, doing, done, and confirmed. In another example, the task status may be defined as the following phases of work progress: in progress, under review, reworking, and rework completed.

That is, the task object handling part 360 may monitor the progress of a task object, update the status of the task object along with the progress of work, and provide information on the progress of the task object. The participants may see a list of task objects associated with the corresponding task project through the task object-only container of the Kanban card, see the status of each individual task by accessing each task object, and see the current progress and statuses of task objects associated with the entire project through the third integration container of the Kanban board.

In an exemplary embodiment, the task object handling part 360 may create a task object based on a chat message, a task message, and a system message, whichever specifies a particular participant. More specifically, the task object handling part 360 may create a task object based on various messages shared through a work chat room. For example, a chat message, a task message, or a system message may be created with a particular participant specified in it, and the task object handling part 360 may obtain information on the specified participant from each message and create a task object associated with this participant. The specified participant may correspond to a task owner or task assignee associated with the task object.

The reminder management part 370 may create a reminder message about task details in the Kanban card and allow it to be shared through the first work chat room. That is, a Kanban card may be created corresponding to a task project, and a reminder message may be created according to the phases of work progress of the task project and shared through the first work chat room, so that the participants in the corresponding task project become aware of the progress of work and efficiently perform their work. Meanwhile, a reminder message may be created as a system message based on a work schedule for the task and shared through the first and second work chat room.

In an exemplary embodiment, the reminder management part 370 may create the reminder message to send to at least some participants by setting reminders to periodically create task notes or reminders for a workflow-based deadline of a task object. The Kanban card may include a task requirement that requires task notes to periodically occur along with the progress of work or a task requirement that requires the task to be done before a set deadline according to the workflow. The workflow may be defined in association with how the status of the Kanban card changes with the progress of work. For example, the workflow may be described by “scheduled”, “in progress”, “overdue”, and “confirmed”, and the workflow-based deadline may correspond to a time limit set up for each status.

In an exemplary embodiment, the reminder management part 370 may create a reminder message at every interval a task note with a reminder setting occurs and allow it to be shared through the first work chat room. The reminder message may be updated along with the progress of an occurrence interval and when a task note occurs. For example, if a task assignee writes a task note or uploads a file within a specific occurrence interval, the corresponding reminder message may be updated and created in the next occurrence interval. Moreover, the status of the corresponding Kanban card may be updated when a task note is written (created), and the corresponding system message may be created and shared through the first work chat room. The status of the Kanban card may be changed to scheduled, in progress, overdue, and confirmed.

In an exemplary embodiment, the reminder management part 370 may create a reminder message according to a deadline with a reminder setting and allow it to be shared through the first work chat room. A Kanban card may be created in the form of a task corresponding to a task object, and if there is a deadline set up in the Kanban card, a reminder message may be created according to the deadline and provided through the first work chat room. For example, the reminder management part 370 may create a reminder message and allow it to be shared through the first work chat room, as the set time limit approaches, with one week, 3 days, or 1 day before the deadline on the Kanban card. The reminder message may include task details, a deadline, etc.

In an exemplary embodiment, the reminder management part 370 may set a new occurrence interval when the task note occurs and update the reminder message at every interval the task note occurs, based on the number of repetitions of the same reminder message. That is, a new occurrence interval for creating a task note may be set when a task note occurs, and the number of repetitions of the reminder message may be accumulated regardless of whether the occurrence interval is updated or not.

In an exemplary embodiment, if the card status corresponds to the second type and the card status remains constant during a predetermined period, the reminder management part 370 may create a reminder message about a status change and allow it to be shared through the first work chat room. That is, if a Kanban card is defined and created in task form and there is no change made to the card status during a predetermined period, a reminder message requesting a change in the card status may be created and shared through the first work chat room. For example, the status of the Kanban card may be changed to new, doing, done, and confirmed according to the progress of the task.

In an exemplary embodiment, if the Kanban card includes a plurality of tasks having respective deadlines, the reminder management part 370 may create a reminder message associated with each of the plurality of tasks and allow it to be shared through the work chat room. For example, if to-dos associated with the Kanban card are defined as a plurality of tasks and each task has a set deadline, the reminder management part 370 may create a reminder message and allow it to be shared, as the deadline approaches.

In an exemplary embodiment, if the plurality of tasks are sequentially linked according to a sequence of work, the reminder management 370 may create an integrated reminder message associated with the sequence of work and allow it to be shared through the work chat room. For example, if to-dos associated with the Kanban card are defined as a plurality of tasks and are sequentially linked together, the reminder management part 370 may create a reminder message according to the sequence of the tasks and allow it to be shared. Once a preceding task is completed, the reminder management part 370 may create a reminder message about a subsequent task and allow it to be shared.

In an exemplary embodiment, when a task object is created through the second work chat room, the reminder management part 370 may create a reminder message associated with the task object and allow it to be shared through the second work chat room and the first work chat room. A task object may be created in the first and second work chat room individually. If a task object is created in the second work chat room, a reminder message may be created and shared in the associated first work chat room, as well as in the second work chat room. This will be described in more details with reference to FIGS. 7A and 7B.

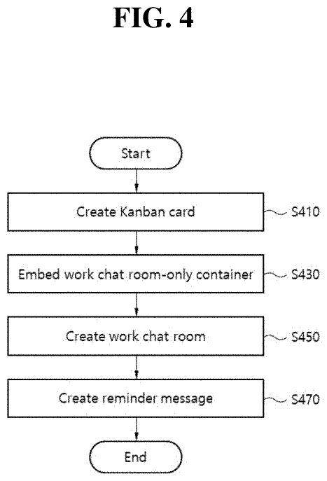

FIG. 4 is a sequential chat of a Kanban-based work processing method according to the present disclosure.

Referring to FIG. 4, the work processing device 130 may create a user-based Kanban board for the management of an entire project through the Kanban board handling part 310. The Kanban board may include first through third integration containers which provide integrated management of task notes, work chat rooms, and task objects created in association with multiple Kanban cards. The first through third integration containers may correspond to DO, CHECK, and ACT tabs.

Afterwards, the work processing device 130 may create a task project in response to a user signal from the user terminal 110, and may create a Kanban card for the management of the task project through the Kanban card creation part 320 to embed it into the Kanban board (step S410). In this case, a work chat room-only container (or second dedicated container) for managing work chat rooms for the corresponding task project only may be created and embedded into the Kanban card (step S430).

In an exemplary embodiment, a task note-only container and a task object-only container (or first and third dedicated containers) for respectively managing task notes and task objects for the corresponding task project only may be created and additionally embedded into the Kanban card. The operation for creating and embedding the first through third dedicated containers may be performed by the Kanban card handling part 330, and the first through third dedicated containers may correspond to the DO, CHECK, and ACT tabs, respectively.

Moreover, the work processing device 130 may create a first work chat room associated with the corresponding Kanban card in the work chat room-only container through the work chat room handling part 350 so that the participants share chat messages about the task project and task messages and system messages about task notes (S450).

Afterwards, the work processing device 130 may create a task note in the task note-only container (or first dedicated container) through the task note handling part 340 so that the participants in a particular task project share basic information about the task, and may create a task object in the task object-only container (or third dedicated container), the task object consisting of a task owner, a task assignee, and task details so that the participants share the assigned task. In this case, an interface for creating a task object may be provided through the first work chat room and a second work chat room, individually. That is, a task object may be created individually in the first work chat room associated with the Kanban card or the second work chat room associated with the task note, and therefore may be linked to the corresponding Kanban card or the corresponding task note.

Moreover, the work processing device 130 may create a reminder message with the progress of the task project associated with the Kanban card through the reminder management part 370 and allow it to be shared through the first work chat room (step S470). For example, a reminder message created by the reminder management part 370 may be created according to an occurrence interval or deadline for a task note in the Kanban card and provided to associated participants. That is, the reminder management part 370 create the reminder message to send to at least some participants by setting reminders to periodically create task notes or reminders for a workflow-based deadline of a task object.

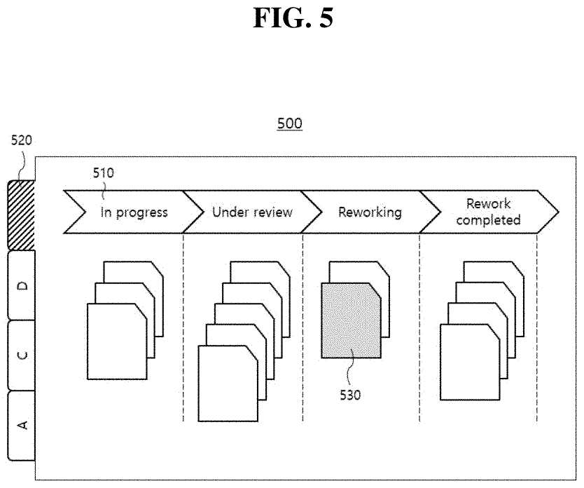

FIG. 5 is a view illustrating a Kanban board according to an exemplary embodiment of the present disclosure.

Referring to FIG. 5, the work processing device 130 may visualize Kanban cards 530 according to the phases 510 of work progress through the Kanban board 500. The Kanban cards 530 may be sorted and arranged according to the phases 510 of work progress, but are not limited thereto and may be organized according to various criteria such as department, task owner, task assignee, deadline, and workflow.

According to an exemplary embodiment, the details of a task may be uploaded onto the “in-progress” Kanban cards 530, and a completed task may be uploaded onto the ‘under review” Kanban cards. Also, when the task assignee or the task owner chooses one of the Kanban cards 530, the work processing device 130 may provide a user interface for the corresponding Kanban card. In this case, the user interface may provide various features (e.g., WRITE, UPLOAD, DELETE, CREATE CHAT ROOM) associated with the Kanban card 530.

For example, the user may access a detailed view of the Kanban card 530 via the user interface, or may access a task note, work chat room, and task object associated with the corresponding task project. Also, the task owner may enter a rework instruction for the completed task through a work chat room associated with the Kanban card. The task owner may enter a rework instruction through a work chat room associated with a particular task note in order to give a more detailed instruction. In this case, a new task object for the rework instruction may be created and uploaded onto the corresponding Kanban card 530. Also, the Kanban card 530, which is updated along with the creation of a new task object, may appear different from the other Kanban cards with no new issues in thickness, brightness, color, etc.

Meanwhile, the Kanban board 500 may include various tabs, apart from a Kanban card area 520 showing the Kanban cards 530. For example, the Kanban board 500 may include D(DO), C(CHECK), and A(ACT) tabs, and each tab may show a list of task notes (or a list of files), a list of work chat rooms, and a list of task objects (or a list of tasks) that belong to the Kanban board 500.

Moreover, the D, C, and A tabs of the Kanban board 500 may correspond to the first through third integration containers. That is, the task notes that can be viewed on the D tab may be embedded into the first integration container for management, the work chat rooms that can be viewed on the C tab may be embedded into the second integration container for management, and the task objects that can be viewed on the A tab may be embedded into the third integration container for management.

Additionally, the task notes, work chat rooms, and task objects (or tasks) on the lists displayed on the tabs may include links to their associated Kanban cards 530. That is, the user may have quick access to the corresponding Kanban cards just by choosing a particular item on the lists. Also, the task notes, the work chat rooms, and the task objects may include permanent links for external sharing. In this case, the user may have direct access to them by selecting a particular item on the lists.

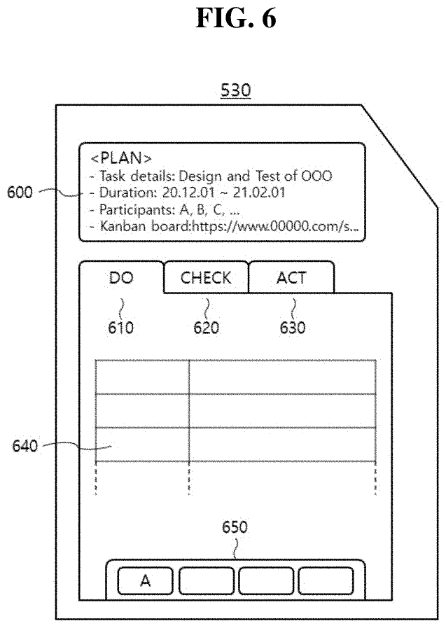

FIG. 6 is a view illustrating a Kanban card according to an exemplary embodiment of the present disclosure.

Referring to FIG. 6, when a new task project is created in a Kanban board, the work processing device 130 may create a Kanban card 530 for the management of the task project and embed it. The created Kanban board 530 may be visually displayed on the Kanban board, and a participant may choose a particular Kanban board 530 and move to the detailed view.

The detailed view of the Kanban card may include a plan area 600, a DO tab 610, a CHECK tab 620, an ACT tab 630, etc. The DO tab 610 may correspond to a first dedicated container, the CHECK tab 620 may correspond to a second dedicated container, and the ACT tab 640 may correspond to a third dedicated container. The plan area 600 may show a brief explanation of the corresponding Kanban card 530. For example, the plan area 600 may show information on the task details, duration, participants, Kanban board, etc. of the Kanban card 530.

Moreover, the Kanban card 530 may provide view information in the form of a list 640 on each tab. For example, the DO tab 610 may provide a list of task notes. The list of task notes may correspond to a list of task notes entered throughout the process of the task project. The list of task notes may include information on registered files as task notes, as well as task notes.

The CHECK tab 620 may provide a list of work chat rooms. The list of work chat rooms may correspond to a list of work chat rooms created throughout the process of the task project. For example, the list of work chat rooms may include a first work chat room uniquely associated with the Kanban card 530, a second work chat room created for each task note, and an one-on-one work chat room created in response to a one-one-one chat request.

The ACT tab 630 may provide a list of task objects. The list of task objects may correspond to a list of task objects created throughout the process of the task project. The task objects in the list may appear look different according to the phases of work progress. For example, the task objects may be classified and marked as new (S1), doing (S2), done (S3), and confirmed (S4) on the list.

Moreover, the work processing device 130 may provide a unique interface 650 on each tab. Each interface 650 may include commands for items managed in the tab. For example, each interface 650 may include commands for creating, modifying, and deleting items.

In addition, actions performed through each tab may be shared as task messages (or system messages) through a work chat room. For example, for a task note created in the DO tab, a task message (or system message) about the creation of the task note may be created and shared through the first work chat room. For a task object created in the ACT tab, a task message (or system message) about the creation of the task object may be created and shared through the first work chat room or the second work chat room.

FIGS. 7A and 7B are views illustrating work chat rooms and a reminder sharing process.

Referring to FIG. 7A, the work processing device 130 may create one first work chat room 710 corresponding to a particular Kanban card 530 through the work chat room handling part 350. That is, when a new Kanban card 530 is created on the Kanban board by the Kanban card handling part 330, the work chat room handling part 350 may create a first work chat room 710 associated with this Kanban card 530 and embed it into the work chat room-only container.

In the first work chat room 710, activities such as writing a note (i.e., the creation of a task note), uploading a file, and making conversation may be performed. To this end, a separate interface for various features may be provided within the first work chat room 710. Subsequently, the first work chat room may provide logs of all activities associated with the Kanban card 530 in chronological order as task messages and system messages within the chat room, thereby enabling the participants to easily understand the progress of the task project.

Moreover, the work processing device 130 may create a second work chat room 720 associated with a particular task note 730 through the work chat room handling part 350. That is, when a new task note 730 is created on the Kanban card by the task note handling part 340, the work chat room handling part 350 may create a second work chat room associated with the corresponding task note 730 and embed it into the work chat room-only container.

In FIG. 7A, a task object x may be created via the interface in the first work chat room 710, and a first reminder 740 associated with the task object x may be created and shared through the reminder management part 370. Moreover, a task object y may be created via the interface in the second work chat room 720, and a second reminder 750 associated with the task object y may be created and shared through the reminder management part 370.

In FIG. 7B, a task object z may be created via the interface in the second work chat room 720, and a third reminder 761 associated the task object z may be created through the reminder management part 370 and shared through the second work chat room 720, and at the same time a third reminder 762 associated with the task object z may be created and shared through the first work chat room 710.

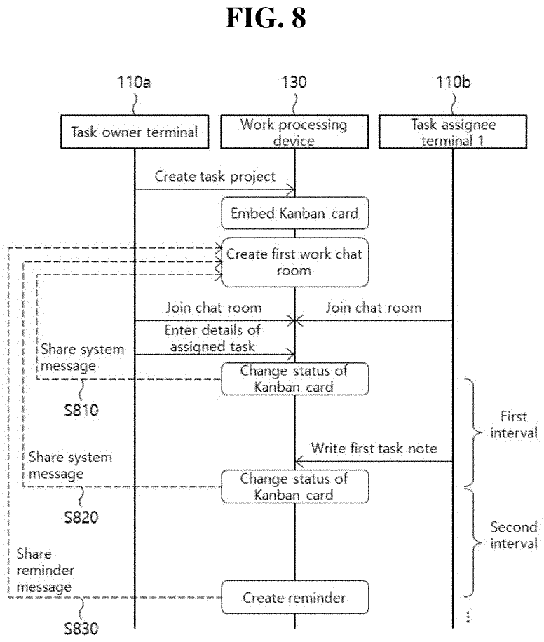

FIG. 8 is a flowchart illustrating a Kanban-based work processing method according to an exemplary embodiment of the present disclosure.

Referring to FIG. 8, the work processing device 130 may provide one first work chat room 710 by default for each Kanban card 530. The participants may communicate in various ways in association with the task project through the first work chat room 710.

For example, when the details of an assignment are uploaded onto the Kanban card by the task owner, the status of the Kanban card may be changed, and a system message about this change may be created and shared through the first work chat room 710 (Step S810).

Moreover, a task note occurrence interval or a task deadline may be set as indicated in the details of the task. If a task assignee write a task note within a first interval for the creation of a task note, this written task note may be uploaded and the status of the Kanban card may be changed, and a system message about this change may be created and shared through the first work chat room 710 (Step S820).

If there is no task note written in the next interval, i.e., a second interval, a reminder may be created at a specific time and shared through the first work chat room 710 (Step S830). Accordingly, the participants may see the flow of the task project or the flow of tasks in chronological order by sequentially looking at the system messages and reminders in the first work chat room, and may receive notifications about the progress of work at proper timings.

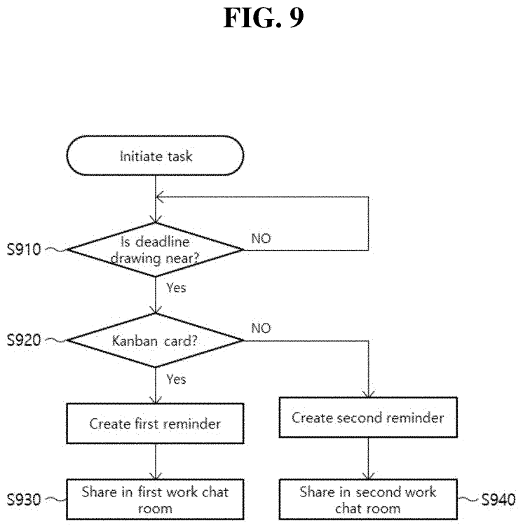

FIG. 9 is a flowchart illustrating a Kanban-based work processing method according to an exemplary embodiment of the present disclosure.

Referring to FIG. 9, the work processing device 130 may create a Kanban board for the management of an entire project. In the Kanban board, a Kanban card may be created in the Kanban board to manage a task project, and a first work chat room uniquely associated with the created Kanban card may be created. The created first work chat room may be embedded into a second integration container of the Kanban board for management.

As a Kanban card is created, the work on an associated task project may be initiated, and deadlines may be set for the Kanban card, task notes, and task objects.

As a deadline is drawing near (for example, 3 days before the deadline), the work processing device 130 may create and send an associated reminder. For example, the work processing device 130 may detect whether the deadline is associated with the Kanban card or not (Step S920), and if so, may create a first reminder and allow it to be shared through the first work chat room (S930). In a case where the deadline is associated with a task note, a second reminder may be created and shared through the second task chat room (S940). If the deadline is associated with a task note, it may mean that the deadline of a task object included in the task note is drawing near.

For example, in a case where there is a deadline set in the details of a task—that is, a deadline for writing periodical task notes, if no task note has been written even till the expiry of the deadline, the work processing device 130 may create a reminder (or first reminder) about the task.

Consequently, the work processing device 130 may create a reminder and allow it to be shared through a work chat room as a deadline is drawing near or has expired in relation to the progress of work, and therefore may efficiently bring a sense of urgency about the task to the participants.

The work processing device 130 according to the present disclosure may provide an effective tool for carrying out and managing a project through a Kanban board and Kanban cards. Moreover, the work processing device 130 may provide dash boards for the Kanban board and Kanban cards. More specifically, the dashboard for the Kanban board may provide a statistical analysis of the Kanban boards P(PLAN), D(DO), C(Check), and A(ACT) in the Kanban board, and the dashboards for the Kanban cards may provide analytical information on the Kanban cards (P) and a statistical analysis of the D, C, and A in each of the Kanban cards.

While the present disclosure has been described above with reference to the exemplary embodiments, it may be understood by those skilled in the art that the present disclosure may be variously modified and changed without departing from the spirit and scope of the present disclosure disclosed in the claims.

The disclosed technique may have the following effects. Provided that, since it is not meant to imply that a particular embodiment should include all of the following effects or only the following effects, the scope of the disclosed technology is not to be construed as limited thereby.

According to an exemplary embodiment of the present disclosure, the user is able to see at a glance the progress of an ongoing project through a Kanban board, to give feedback on tasks and rework them in an effective way through a chat room uniquely associated with a Kanban card and a separate chat room associated with a task note, and to easily understand the workflow through system messages and reminders which are created and shared as work progresses, thereby improving the efficiency of work.

Particularly, the system messages and reminders shared in the chat room associated with the Kanban card through this process provide information at right time about a status change or delay, along with the progress of the task in question, thereby allowing the participants to work efficiently.

What is claimed is:

1. A Kanban-based work processing device comprising:
a Kanban card creation part that detects the creation of a task project from a Kanban board and creates a Kanban card;
a Kanban card handling part that embeds a work chat room-only container for the task project into the Kanban card;
a work chat room handling part that creates a work chat room in the work chat room-only container and allows participants to share task messages through the work chat room; and
a reminder management part that creates a reminder message about task details in the Kanban card and allows the same to be shared through the work chat room.

2. The Kanban-based work processing device of claim 1, wherein the Kanban card handling part embeds a task note-only container for the task project into the Kanban card.

3. The Kanban-based work processing device of claim 2, further comprising a task note handling part that creates task notes in the task note-only container so that the participants share basic information about the task.

4. The Kanban-based work processing device of claim 3, wherein the task note handling part detects a file message uploaded onto the work chat room and creates a file-based task note on the file message.

5. The Kanban-based work processing device of claim 3, wherein the work chat room handling part detects the creation of the task note and creates a task note-based work chat room associated with the task note in the work chat room-only container so that the participants share individual messages about the task note.

6. The Kanban-based work processing device of claim 5, wherein, once a task note-based task object is created through the task note-based work chat room, the work chat room handling part automatically creates a system message for the task note-based task object and allows the system message to be shared through the task note-based work chat room.

7. The Kanban-based work processing device of claim 1, wherein the Kanban card handling part embeds a task object-only container for the task object into the Kanban card.

8. The Kanban-based work processing device of claim 7, further comprising a task object handling part that creates a task object in the task object-only container, the task object consisting of a task owner, a task assignee, and task details contained in the task message, and provides the task object to the work chat room so that the participants share the assigned task.

9. The Kanban-based work processing device of claim 8, wherein the task object handling part creates a task object based on a chat message, a task message, or a system message, whichever specifies a particular participant.

10. The Kanban-based work processing device of claim 8, wherein the task object handling part embeds a task note-based task object created through a task note-based work chat room in the task object-only container.

11. The Kanban-based work processing device of claim 1, wherein the work chat room handling part detects a change in the status of the Kanban card and automatically creates a system message about the change in the status and allows the same to be shared through the work chat room.

12. The Kanban-based work processing device of claim 1, wherein, if an external user with no authorization to access the Kanban board is invited to join the work chat room, the external user is given authorization to access the Kanban board, Kanban card, or task note.

13. The Kanban-based work processing device of claim 1, wherein the reminder management part creates a reminder message as a system message based on a work schedule for the task and allows the same to be shared through the work chat room.

14. The Kanban-based work processing device of claim 1, wherein the reminder management part creates the reminder message to send to at least some participants by setting reminders to periodically create task notes or reminders for a workflow-based deadline of a task object.

15. The Kanban-based work processing device of claim 14, wherein the reminder management part sets up a new occurrence interval when the task note occurs and updates the reminder message at every interval the task note occurs, based on the number of repetitions of the same reminder message.

16. The Kanban-based work processing device of claim 1, wherein, if the Kanban card comprises a plurality of tasks having respective deadlines, the reminder management part creates a reminder message associated with each of the plurality of tasks and allows the same to be shared through the work chat room.

17. The Kanban-based work processing device of claim 16, wherein, if the plurality of tasks are sequentially linked according to a sequence of work, the reminder management part creates an integrated reminder message associated with the sequence of work and allows the same to be shared through the work chat room.

18. A work processing method performed by a Kanban-based work processing device, the work processing method comprising:
detecting the creation of a task project from a Kanban board and creates a Kanban card;
embedding a work chat room-only container for the task project into the Kanban card;
creating a work chat room in the work chat room-only container and allowing participants to share task messages through the work chat room; and
creating a reminder message about task details in the Kanban card and allowing the same to be shared through the work chat room.
